(19) United States
(12) Patent Application Publication
(10) Pub. No.: US 2022/0236413 A1
(43) Pub. Date: Jul. 28, 2022

(54) LASER SCANNER APPARATUS AND METHOD OF OPERATION

(71) Applicant: Omron Corporation, Kyoto (JP)

(72) Inventors: Gianmarco Grange, Turin (IT); Krishnan Ramanathan, Roermond (NL); Adam Sowul, Pleasanton, CA (US); Yoshiharu Tani, Kyoto-shi (JP)

(21) Appl. No.: 17/582,693

(22) Filed: Jan. 24, 2022

Related U.S. Application Data
(60) Provisional application No. 63/141,577, filed on Jan. 26, 2021.

(51) Int. Cl. G01S 17/10; G01S 7/481; G01S 7/4865

(52) U.S. Cl. CPC G01S 17/10; G01S 7/4814; G01S 7/4865; G01S 7/4817; G01S 7/4816

(57) ABSTRACT

Various embodiments of a laser scanner apparatus and a method of operating a laser scanner apparatus, as disclosed herein, include the use of a variably blocked aperture or a controlled defocusing in relation to receiving backscattered light. One or more embodiments combine both variable blocking and defocusing and may use a lens design that complements the blocking and defocusing. Among the various advantages offered by one or more embodiments disclosed herein is a laser scanner apparatus that exhibits a flatter response curve to backscattered light over a defined range of distances. That is, among other advantages of the configurations and operating methods disclosed herein, a laser scanner apparatus experiences less variation in the optical power delivered to its photodetector arrangement, in relation to detecting an object at different distances within a defined range.

### TECHNICAL FIELD

Various embodiments of a laser scanner apparatus and a method of operating a laser scanner apparatus, as disclosed herein, include the use of a variably blocked aperture or a controlled defocusing in relation to receiving backscattered light.

### BACKGROUND

A typical laser scanner apparatus, or simply “scanner.” emits a laser pulse into a surrounding physical environment and detects one or more “return” or “reflection” pulses, as backscattered from one or more objects in the surrounding environment. By way of example, a scanner may “sweep” a defined angular range within a horizontal plane, e.g., 180 degrees, or it may sweep through defined horizontal and vertical ranges, emitting one or more pulses at each angular step and correspondingly monitoring for backscattered light. Monitoring for return reflections with respect to each emitted laser pulse may be confined to an interval corresponding to minimum and maximum detection distances of the scanner—i.e., a working “detection” range”—according to time-of-flight (ToF) principles.

An example scanner includes a transmitter arrangement operative to emit laser pulses and a receiver arrangement operative to detect corresponding backscattered light, where the optical paths for transmission from the scanner and reception by the scanner may be coaxial. A scanning mirror may be used to receive backscattered light and direct it towards a photodetector of the scanner, where the angle subtended by the mirror is greater for closer objects and lesser for more distant objects.

Consequently, backscattered light from objects tends towards a paraxial approximation with increasing object distance, and the differences in ray divergence of backscattered light as a function of object distance influence the performance of the optical receive path in a typical scanner. Other distance-related factors that are recognized herein as affecting such performance further include poor focusing performance regarding objects that are closer than a defined threshold.

### SUMMARY

Various embodiments of a laser scanner apparatus and a method of operating a laser scanner apparatus, as disclosed herein, include the use of a variably blocked aperture or a controlled defocusing in relation to receiving backscattered light. One or more embodiments combine both variable-blocking and defocusing and may use a lens design that complements the blocking and defocusing. Among the various advantages offered by one or more embodiments disclosed herein is a laser scanner apparatus that exhibits a flatter response curve to backscattered light over a defined range of distances. That is, among other advantages of the configurations and operating methods disclosed herein, a laser scanner apparatus experiences less variation in the optical power delivered to its photodetector arrangement, in relation to detecting an object at different distances within a defined range.

A laser scanner apparatus according to one embodiment includes an optical transmitter arrangement configured to transmit a laser pulse into a surrounding physical environment of the laser scanner apparatus. Further included, an optical receiver arrangement is configured to receive backscattered light at a mirror and project the received backscattered light as a projected beam towards an aperture interposed between a lens and the mirror. The lens is configured to focus backscattered light passed by the aperture towards a photodetector, and the aperture configured to impart no blocking of the projected beam with respect to the lens, for beam sizes that do not exceed a fixed central region of the aperture.

However, the aperture imparts a variable blocking of the projected beam with respect to the lens, for beam sizes that are larger than the central region of the aperture. Variable blocking is provided by a fixed annular region of the aperture surrounding the central region. The amount of blocking increases within the annular region as a function of radial distance from the optical axis of the lens, on which the central region of the aperture is centered. As such, the annular region may be considered as providing progressively more blocking, with increasing radius. Progressive blocking in this manner prevents some of the light associated with larger, more divergent beams from reaching the lens, with the amount of blocking becoming more aggressive (greater) with increasing beam size, for beams that are larger than the diameter of the central portion of the aperture. Here, “beam size” may be understood as beam diameter taken in the plane defined by the surface of the aperture facing the mirror, where that plane is transverse to the optical axis of the lens.

In another embodiment, a method performed by a laser scanner apparatus includes transmitting a laser pulse into a surrounding physical environment of the laser scanner apparatus. Further, the method includes the laser scanner apparatus receiving backscattered light and projecting it towards a lens as a projected beam centered on the optical axis of the lens, wherein the lens operates as a focusing lens for a photodetector of the laser scanner apparatus that is used to sense backscattered light. Still further, the method includes blocking the backscattered light with respect to the lens, for beam sizes of the projected beam that exceed a first beam size, wherein the blocking is progressive as a function of radial distance from the optical axis of the lens, for beam sizes between the first beam size and a larger, second beam size.

As noted above, various embodiments disclosed herein offer the advantage of flattening the sensitivity curve of a laser scanner apparatus over its operating (distance) range. That advantage is gained in whole or in part by any one or more of the following operations or configurations: (a) a controlled defocused position of the photodetector with respect to the ideal focal plane of the receiver lens; and (b) implementation of the laser scanner apparatus according to a mathematical model of the receiver lens, aperture, and object-distance ranges that leads to the definition of light breaking structures at the inner edge (circumference) of the aperture, with a geometry aimed at equalizing the optical power delivered from the lens to the photodetector, for backscattered coming from an object at different distances from the laser scanner apparatus.

The contemplated sawtooth profile of the light breaking structures of the aperture in at least one embodiment is symmetric about the optical axis of the lens, with defined angles and thicknesses for the tooth portions. Further, the receiver lens has a geometry that in tandem with the geometry of the aperture and yields further smoothing of the sensitivity curve of the laser scanner apparatus.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of one embodiment of a laser scanner apparatus.

FIG. 2 is a block diagram of example details for a laser scanner apparatus, according to one embodiment.

FIGS. 3-5 are block diagrams of an aperture for use in a receive optical path of a laser scanner apparatus, according to one or more embodiments.

FIG. 6 is a block diagram of examples of backscattered light returned to a laser scanner apparatus, for objects at different distances from the laser scanner apparatus.

FIGS. 7-9 are diagrams of further example details for an aperture for use in a receive optical path of a laser scanner apparatus, according to one or more embodiments.

FIG. 10 is a cutaway, side view of an example optical subassembly for a receive optical path of a laser scanner apparatus, according to one embodiment.

FIG. 11 is a block diagram of an example arrangement for defocusing a photodetector with respect to a lens, within a receive optical path of a laser scanner apparatus, according to one embodiment.

FIG. 12 is a diagram illustrating an example of shadowing by a laser transmitter module in an optical transmitter arrangement of a laser scanner apparatus, onto an aperture in an optical receiver arrangement of the laser scanner apparatus.

FIG. 13 is a plot of example sensitivity curves of a laser scanner apparatus, depicting sensitivity as a function of object distance, with and without sensitivity compensation as contemplated herein.

FIG. 14 is a logic flow diagram of one embodiment of a method performed by a laser scanner apparatus.

### DETAILED DESCRIPTION

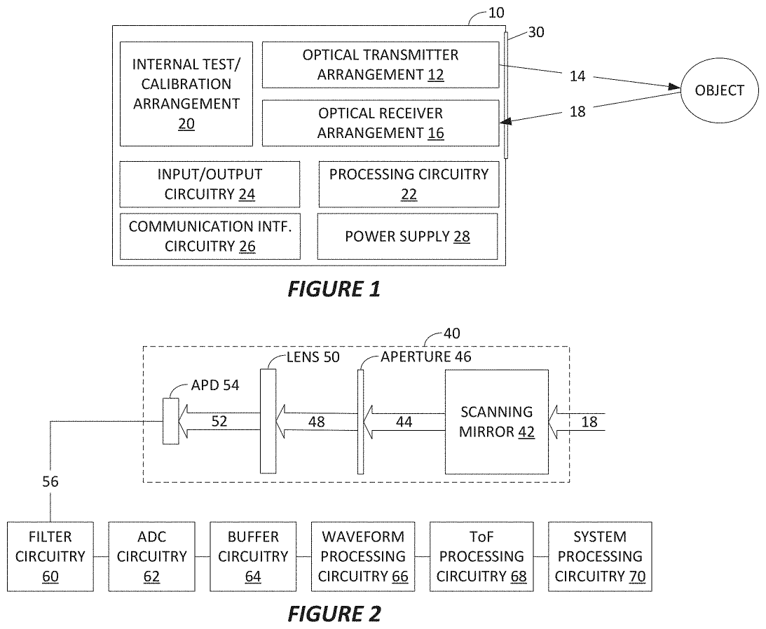

FIG. 1 depicts an example laser scanner apparatus 10, which may also be referred to as “apparatus 10” or “scanner 10.” In at least one example, the apparatus 10 determines distances to objects detected in its surrounding physical environment, based on the time-of-flight principle, according to which the apparatus 10 measures the time elapsed between its transmission of a laser pulse into the environment and its detection of the return reflection(s).

Here, the “reflections” are backscattered light from the object(s) illuminated by the transmitted laser pulse. Detecting the reflected pulses comprises, for example, monitoring a photodetector signal output by a photodetector of the apparatus 10 over an interval referenced to the transmission event, detecting signal pulse(s) within the monitored photodetector signal, and determining an elapsed time between the transmission event and the occurrence(s) of the detected signal pulses. Of course, “detection” in this regard may involve relatively complex filtering and waveform processing, for rejection of noise, separation of closely-spaced reflections, etc.

Casting the above operations against the implementation details of the example apparatus 10 depicted in FIG. 1, the apparatus 10 includes an optical transmitter arrangement 12 that is configured to transmit a laser pulse 14 outward into its surrounding environment. Assuming the transmitted laser pulse 14 strikes a reflective object that falls within the detection capabilities of the apparatus 10 in terms of object size, reflectivity, and distance from the apparatus 10, the apparatus 10 receives backscattered light 18 comprising one or more return reflections, referred to as a “return pulses” or “reflected pulses.” Generally, an optical receiver arrangement 16 of the apparatus 10 receives only a portion of the light backscattered by the object, and “backscattered light 18” refers to the reflected pulses incoming to the optical receiver arrangement 16.

Further elements of the example apparatus 10 include an internal test/calibration arrangement 20, which may include one or more types of reflective targets and associated circuitry within the apparatus 10. The apparatus 10 uses such an arrangement to verify ongoing detection capabilities of the apparatus 10, e.g., for use of the apparatus 10 in safety-critical monitoring applications, such as where the apparatus 10 scans a two-dimensional area or a three-dimensional volume, for object intrusions.

Other example elements include processing circuitry 22, input/output (I/O) circuitry 24, and communication interface circuitry 26. The processing circuitry 22 comprises fixed circuitry, programmatically-configured circuitry, or some combination of both. Example processing circuitry includes any one or more of Field Programmable Gate Arrays (FPGAs). Complex Programmable Logic Devices (CPLDs). Application Specific Integrated Circuits (ASICs). System-on-a-Chip (SoC) modules, Digital Signal Processors (DSPs), microcontrollers, or microprocessors. In at least some embodiments, such circuitry includes or is associated with one or more types of computer-readable media used for storing one or both of configuration data, operating logs, and computer-program instructions, the execution of which at least partially configures the apparatus 10 to operate in the manner(s) described herein.

I/O circuitry examples include solid-state or mechanical (“dry”) relay outputs. e.g., for gating power to machinery, triggering external events, activating alarms, activating visual or audible annunciators, etc. Examples of the communication interface circuitry 26 include network interface cards (NICs), such as for Ethernet or other data-networking protocols. The communication interface circuitry 26 may implement more than one physical interface and more than one set or type of communication protocols, depending upon operational requirements, factory-floor network types, etc. Similarly, the power supply 28 comprises, for example, an AC/DC converter that receives mains power and provides the various DC voltages needed within the apparatus 10. Of course, other power-supply configurations are contemplated.

The apparatus 10 may be housed in a dustproof and splash-resistant housing, to prevent contamination of its optical components and may include an optical window 30 for emitting laser pulses 14 and receiving backscattered light comprising reflected pulses 18. After passing through any such window 30, the backscattered light “enters” the optical receiver arrangement 16, which includes an optical receive path.

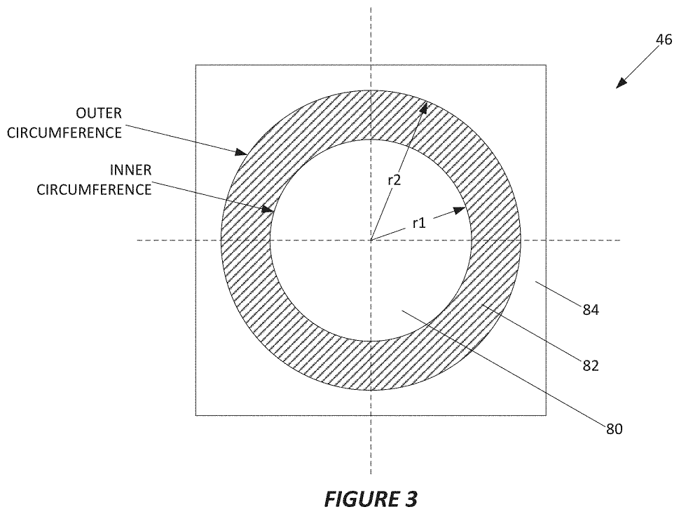

FIG. 2 illustrates example details for an optical receive path 40, with the example arrangement including a scanning mirror 42 that is configured to project the backscattered light 18 as a projected beam 44, towards an aperture 46. The projected beam 44 passes completely or partly through the aperture 46, such that the amount of backscattered light 48 that impinges on a lens 50 depends on whether or to what extent the projected beam 44 is blocked by the aperture 46. Correspondingly, the backscattered light 48 that impinges on the lens 50 is focused towards a photodetector 54 of the apparatus 10, as focused light 52. In at least one embodiment, the photodetector 54 is an avalanche photodiode, which is denoted in FIG. 2 as an “APD.”

A photodetector signal 56 output from the photodetector 54 is an electrical signal that responds to backscattered light impinging on its active surface area. Detailed later herein are embodiments of the apparatus 10 where the photodetector 54 is positioned at an offset relative to the focal plane of the lens 50—i.e., it is “defocused” with respect to the lens 50. The offset is along the optical axis of the lens 50, either towards the lens 50 or away from the lens 50. As such, some of the rays of the focused light 52 may not strike the active surface of the photodetector 54.

In at least one embodiment, the photodetector signal 56 is an analog electrical signal that increases in amplitude in proportion to the optical power received at the active surface of the photodetector 54. Return reflections of the transmitted laser pulse 14 that are received at the apparatus 10 as backscattered light 18 are manifested in the photodetector signal 56 as signal pulses having a peak amplitude corresponding to the peak optical power impinging on the photodetector 54. One transmitted laser pulse 14 may produce multiple reflections, and the photodetector signal 56 may exhibit multiple signal pulses over the interval of interest, along with spurious movements and other noise.

Filter circuitry 60 provides some noise rejection and bandwidth limiting of the photodetector signal 56, in advance of analog-to-digital converter (ADC) circuitry 62, which outputs a series of digital samples over the interval of interest, for temporary storage in a buffer circuitry 64. Waveform processing circuitry 66 evaluates the series of digital samples held in the buffer circuitry 64. e.g., for peak detection and corresponding pulse identification. Time-of-flight (ToF) processing circuitry 68 performs ToF calculations, using the temporal position(s) of the detected pulse(s) within the series of digital samples, and system processing circuitry 70 responds to the ToF determinations. e.g., by carrying out various actions in dependence on whether an object was detected or at what distance. Such operations may include qualification operations, for more reliable detection, and may be repeated at high speed over one or more angular scanning ranges.

Turning back to illustrated details, the optical receiver arrangement 16 is configured to receive backscattered light 18 at a mirror 42 and project the received backscattered light 18 as a projected beam 44 towards the aperture 46, which is interposed between a lens 50 and the mirror 42. The lens 50 is configured to focus backscattered light 48 passed by the aperture 46 towards the photodetector 54. Particularly, the aperture 46 in one or more embodiments is configured to impart no blocking of the projected beam 44 with respect to the lens 50, for beam sizes that do not exceed a fixed central region of the aperture 46 and impart a variable blocking of the projected beam 44 with respect to the lens 50, for beam sizes that are larger than the central region of the aperture 46. A fixed annular region of the aperture 46 surrounds the central region and provides the progressive blocking, with the amount of blocking increasing within the annular region as a function of radial distance from the optical axis of the lens 50, on which the central region of the aperture 46 is centered.

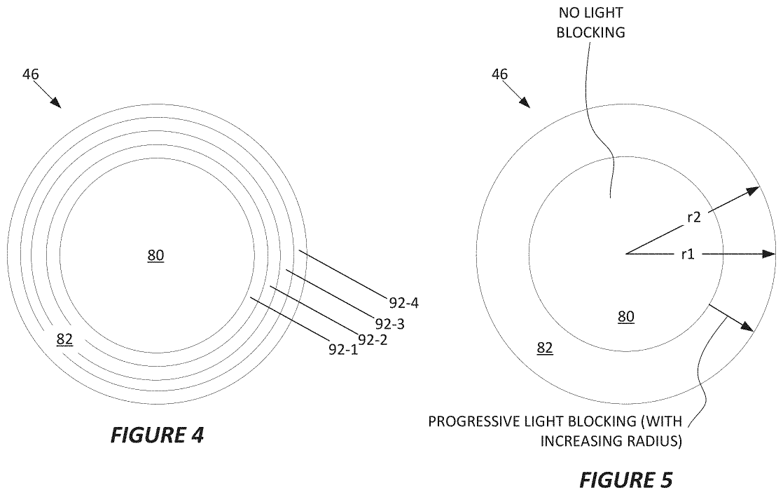

FIG. 3 illustrates an example configuration of the aperture 46, shown in a plan view—i.e., looking towards the lens 50, along the optical axis of the lens 50. In other words, FIG. 3 depicts the “face” of the aperture 46 seen from the perspective of the mirror 42.

A central region 80 of the aperture 46 is open and free of obstruction, with the circumferential boundary that defines the central region 80 at a radius r1 from the optical axis of the lens 50, where, in assembled form, the aperture 46 is centered around the optical axis of the lens 50. An annular region 82 surrounds the central region 80 of the aperture 46 and occupies the circular area lying between the radius r1 and the radius r2. The annular region 82 imparts a variable blocking for beam sizes of the projected beam 44—see FIG. 2—that have beam diameters in the range of 2×r1 to 2×r2. Here. “variable blocking” denotes a progressive blocking, wherein the amount of light blocking increases as a function of increasing radius from the optical axis of the lens 50, for radii in the range between r2−r1.

The intensity of the backscattered light 18 varies as a function of distance, for an object having a given reflectivity. Consequently, the optical power delivered to the photodetector of a typical conventional scanner may vary sharply as a function of object distance. There may a close-in range of distances that are too close for focusing by the typical scanner, meaning that the photodetector receives comparatively little optical power. Beyond that close-in range lies “near-field” range of distances that begin falling into the focusing capabilities of the typical scanner, and the scanner delivers increasing optical power to its photodetector as object distance increases and focusing performance improves. Beyond the near-field range of distances and out to a maximum detection distance of the scanner lies a “far-field” range, and the typical scanner tends to experience decreasing optical power with increasing object distance over the far-field range.

One way to appreciate the configuration and resulting operation of the aperture 46 depicted in FIG. 3 is to recognize that the radius r1 may be dimensioned for passing beam sizes associated with a first range of object distances, e.g., a far-field range, whereas the radii between r1 and r2 correspond to beam sizes associated with a closer, second range of object distances. e.g., a near-field range. As such, the amount of beam blocking varies as a function of beam size, with the larger, more intense beams associated with decreasing object distance in the near-field range experiencing progressively greater light blocking, with respect to that portion of the beam that impinges on the annular region 82 of the aperture 46. The further surrounding region 84 of the aperture 46 may be opaque and include structural features for assembly and mounting. Thus, the radius r2 that defines the outer circumference of the annular region 82 may be set according to a maximum beam size associated with the closest distance in the near-field range.

With the annular region 82 effectively providing a variable transmissivity between radius r1 and radius r2, one or more embodiments of the aperture 46 form the annular region 82 using a transparent medium that darkens with increasing radius or otherwise exhibits decreasing transmissivity with increasing radius, for radii between r1 and r2. The decrease may be continuous or non-continuous, e.g., stepped increases in light blocking. FIG. 4 illustrates one embodiment of stepped increases in light blocking, where concentric rings 92-1, 92-2, 92-3, and 92-4 form the annular region 82, with each next (larger) ring 92 having more light blocking. FIG. 5 illustrates the other approach, where the annular region 82 provides continuously increasing blockage. The term “progressive blocking” encompasses both stepped increases in blocking and continuous or gradual increases in blocking.

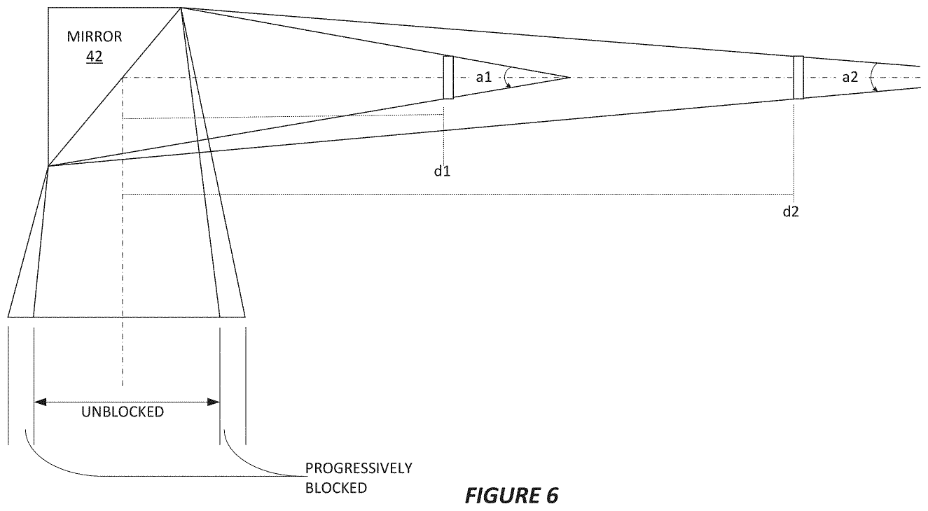

FIG. 6 offers additional understanding of the blocking effect, where the mirror 42 subtends a larger angle a1 for an object at a distance d1, as compared to the angle a2 subtended for the same object at a distance d2. The beam projected by the mirror 42 is larger for the object at the distance d1 and the outer extents or portion of the beam that fall onto the annular region 82 of the aperture 46 experience progressive light blocking, while that portion of the beam corresponding to the central region 80 of the aperture 46 experiences no blocking. The beam size associated with the object at distance d2 falls entirely within the central region 80 of the aperture 46.

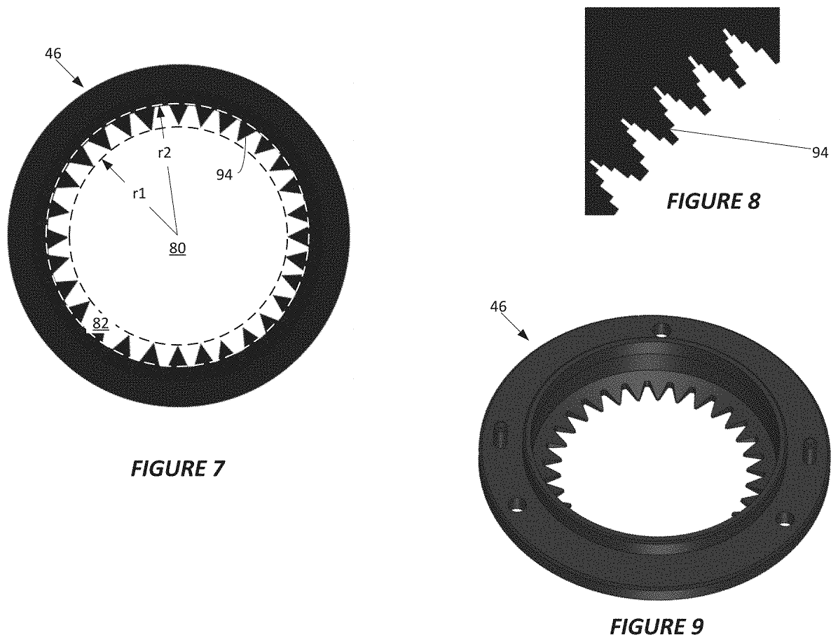

FIG. 7 illustrates another embodiment of the aperture 46, where light breaking structures 94 ring the central region 80 in a radial array and form the annular region 82. Here, the light breaking structures 94 comprise “saw teeth” that point towards the center of the open central region 80 of the aperture 46, meaning that the width of the saw teeth increases with increasing radius from the center of the central region 80—i.e., from the optical axis of the lens 50. As such, the aggregate or overall amount of light blocking provided by the saw teeth depends on the radial distance from the center of the central region 80, which is aligned on the optical axis of the lens 50. The taper of the saw teeth provides progressively more light blocking for increasing radii between radius r1 and radius r2.

FIG. 8 offers a close-up view of the light breaking structures 94 in one embodiment, where only a small portion of the aperture 46 is shown. The depicted embodiment shows a stepped progression with respect to the taper, rather than a smooth, continuous progression. Using a stepped progression of the sort illustrated defines concentric rings, with each next ring in order of increasing radius from the optical axis providing a greater amount of light blocking. As such, the stepped taper seen in FIG. 8 represents another approach to achieving the concentric-ring arrangement shown in FIG. 4.

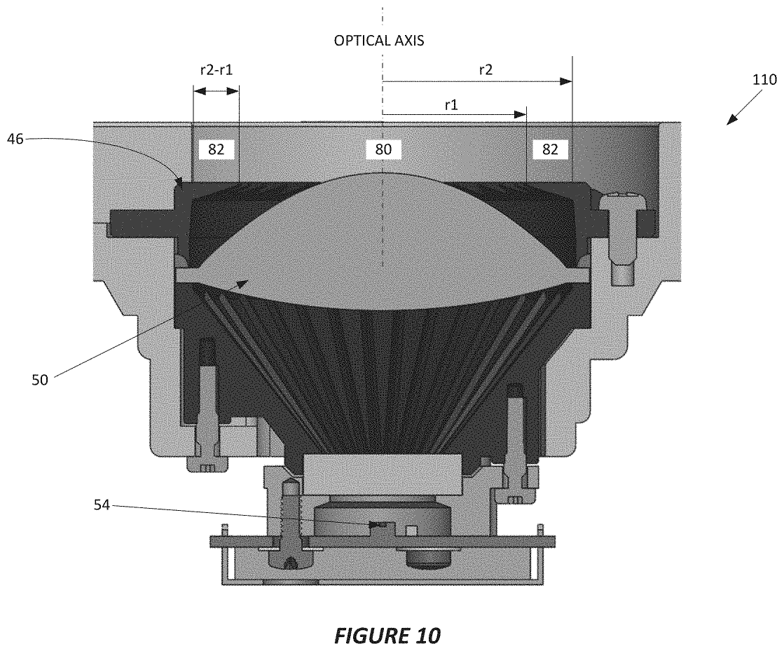

FIG. 9 depicts the aperture 46 according to one embodiment, with the aperture 46 shown in perspective. FIG. 10 illustrates an optical subassembly 110 according to one embodiment of the optical receiver arrangement 16 introduced in FIG. 1, for the apparatus 10. Included in the optical subassembly 110—which is shown in cross-section from a side view—are the aperture 46, the lens 50, and the photodetector 54, in an assembled arrangement.

Notable details in the example embodiment depicted in FIG. 10 for the optical subassembly 110 include a clear illustration of the “shadowing” arrangement of the aperture 46 with respect to the lens 50. The central region 80 of the aperture 46 aligns on the optical axis and is open or otherwise 100% transmissive, meaning that it imparts no blocking or reduction of light rays passing through the central region 80. The annular region 82 that surrounds the central region 80 provides a progressive blocking or shadowing of light rays, with increasing radius from the optical axis of the lens 50, meaning that progressive light blocking occurs with respect to the lens surface area(s) that are shadowed by the annular region 82 of the aperture 46.

In one or more embodiments, at least for a defined range of distances, the variable blocking provided by the aperture 46 reduces distance-related variations in the optical power delivered to the photodetector 54 that would otherwise arise because of the beam size of the projected beam 44 being dependent upon the distance between the apparatus 10 and an object in the surrounding environment that provides the backscattered light 18 received by the apparatus 10.

In an example arrangement, in cases where the beam size of the projected beam 44 does not exceed the size of the central region 80 of the aperture 46, the aperture 46 imparts no reduction in the optical power delivered to the photodetector 54. In cases where the beam size of the projected beam 44 exceeds the size of the central region 80 of the aperture 46, the aperture 46 imparts a reduction in the optical power delivered to the photodetector 54, with the amount of the reduction depending on the beam size (at least for beam sizes that fall within the size range defined by the annular region 82 of the aperture 46).

For example, the size—e.g., diameter—of the central region 80 is dimensioned for beam sizes of the projected beam 44 that correspond to a first range of distances, and an overall size of the central region 80 plus the annular region 82 is dimensioned for beam sizes of the projected beam that correspond to a second range of distances. The second range is closer to the apparatus than the first range. Backscattered light 18 returned to the apparatus 10 from objects at distances in the first range is substantially paraxial with the optical axis of the optical receiver arrangement 16 and backscattered light 18 returned to the apparatus 10 from objects at distances in the second range is not substantially paraxial with the optical axis of the optical receiver arrangement 16. Because the optical axis of the optical receiver arrangement is the optical axis of the lens 50, as “projected” onto the mirror 42, one may refer to the backscattered light 18 being paraxial, or not paraxial, with the optical axis of the lens.

A circumferential edge of the aperture 46 surrounds the central region 80 of the aperture 46, which central region 80 is open. The circumferential edge in one or more embodiments has a sawtooth contour that provides progressive light blocking. As an example, the central region 80 of the aperture 46 is open and ringed by plurality of circumferentially-arrayed tapered projections having tips extending towards the center of the aperture 46 and terminating at a first radial distance (r1) from the center of the aperture 46. The first radial distance defines the size of the central region 80 and the tapered projections provide increased beam blocking with increasing radial distance from the center of the aperture 46.

In at least one embodiment of the optical receiver arrangement 16, the arrangement 16 includes a photodetector 54 that provides an output signal responsive to the projected beam 44, as directed towards the photodetector 54 by the lens 50. That is, the photodetector 54 is responsive to the backscattered light that is passed by the aperture 46 and focused by the lens 50 towards the active surface of the photodetector 54. In one or more embodiments, the active surface of the photodetector 54 is positioned along the optical axis of the lens 50 at an offset from the focal plane of lens 50. The offset positions the active surface of the photodetector closer to the lens (or further from the lens), so that less than all the focused light, as redirected by the lens 50 towards the photodetector 54, falls on the active surface of the photodetector 54, for beam sizes greater than a defined size. The defined size corresponds to a near-field range of distances from the apparatus 10, for example.

Broadly, in one or more embodiments of the apparatus 10, the spacing between the lens 50 and the photodetector 54 partially “defocuses” the photodetector 54 with respect to the lens 50, to flatten a sensitivity curve of the apparatus 10 that is associated with characteristically higher beam powers of the backscattered laser beam, for an object that is within a near-field distance range from the apparatus, as compared with a far-field distance range. The “amount” or degree of defocusing is configured to provide a certain amount of flattening of the sensitivity curve, while preserving a minimum sensitivity of the optical receiver arrangement 16.

In one or more embodiments, the lens 50 is a bi-convex aspheric lens, and the unobstructed central region 80 of the aperture 46 is a circular area having a diameter that is less than a width of a reflecting surface of the mirror 42, which projects the backscattered light 18 towards the aperture 50 as a projected beam 44. Such a lens design complements the imposition of progressive light blocking by the aperture 46, as described herein.

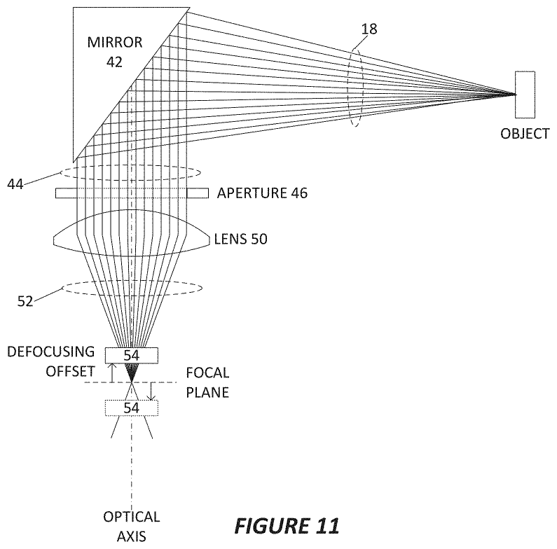

FIG. 11 illustrates another technique for implementation of the optical receiver arrangement 16 of the apparatus 10, for reducing variations in the amount of optical power delivered to the photodetector 54, for an object at different distances from the apparatus 10, at least for distances within a defined detection range. Referring to reducing the variations in optical power delivered to the photodetector 54 as a function of object distance is another way of describing the flattening of the sensitivity curve of the apparatus 10.

The technique comprises operating the photodetector 54 at a defocused position with respect to the lens 50, meaning that the active surface of the photodetector in a plane transverse to the optical axis is not aligned with the focal plane of the lens 50. Instead, the active surface of the photodetector 54 is offset along the optical axis. One embodiment uses a negative offset, towards the lens 50, while another embodiment-emphasized by showing the photodetector 54 in dashed lines-uses a positive offset, away from the lens 50. Here. “towards” and “away” refer to displacement of the active surface of the photodetector along the optical axis of the lens 50, either closer to the lens 50 or further from the lens 50.

Another way to describe the technique illustrated in FIG. 11 is “defocusing” the photodetector 54 with respect to the lens 50. Defocusing is used in combination with progressive blocking via the aperture 46 in some embodiments, with the design parameters of the aperture 46 and the amount of defocusing determined in a complementary or joint fashion. Other embodiments use progressive blocking without defocusing, and still other embodiments use defocusing without progressive blocking.

“Defocusing” does not mean a significant defocusing but rather implies a slight or small defocusing, in which the photodetector 54 is purposefully offset from the ideal focal plane of the lens 50, where the offset is along the optical axis of the lens 50. Defocusing via the purposeful offsetting of the photodetector 54 results in a more uniform delivery of optical power to the photodetector 54 for a given object illuminated by the apparatus 10, occupying different distances within the detection range of the scanner.

More particularly, the photodetector 54 does not experience a sharp peak in delivered optical power at the transition point between near-field optical performance of the apparatus 10 and far-field optical performance of the apparatus 10. That transition point corresponds to the object distance at which the backscattered light 18 still has a high intensity as compared to the intensity seen at greater distances for the same object reflectivity but where the rays of the backscattered light 18 begin taking on a paraxial approximation with respect to the optical axis of the optical receiver arrangement 16. That axis is a projection of the optical axis of the lens 50.

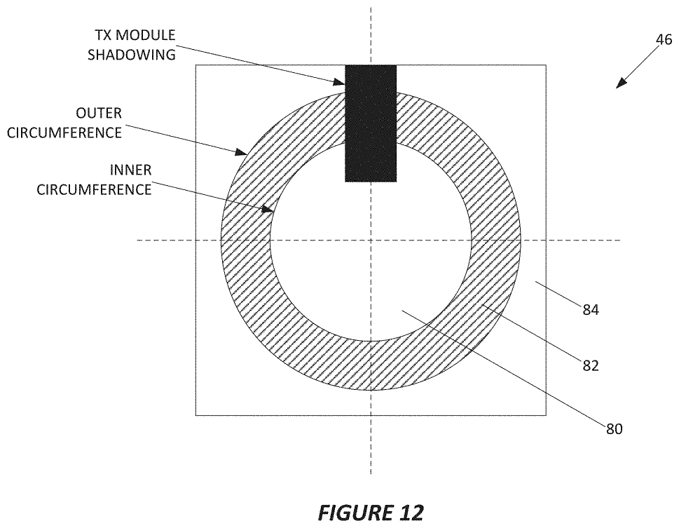

FIG. 12 illustrates another aspect of the aperture 46 in one or more embodiments, wherein the optical axis of the optical transmitter arrangement 12 is coaxial with that of the optical receiver arrangement 16, which results in a partial “shadowing.” That shadowing projects onto the aperture 46 and thus onto the underlying lens 50. In other words, the transmitter-module shadowing imposes a certain amount of light reduction with respect to the projected beam 44 produced by the mirror and, correspondingly, with respect to the focused light 52 produced by the lens 50. The amount and progressivity of light blocking provided by the annular region 82 of the aperture 46 and/or the amount of defocusing of the photodetector 54 relative to the lens 50 accounts for the “lost” optical power associated with the shadowing caused by the transmitter module of the optical transmitter arrangement 12.

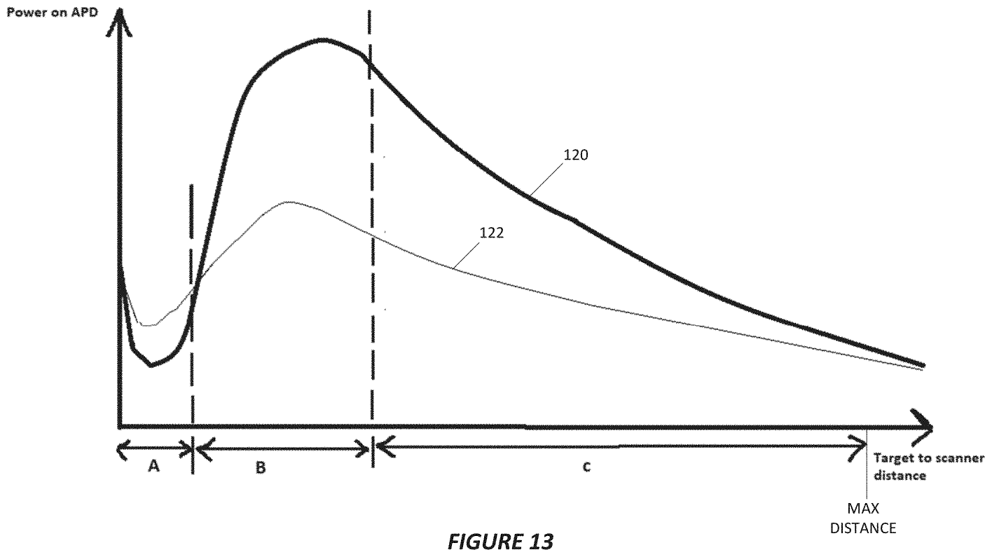

FIG. 13 is an example plot of a “sensitivity” curve 120 for an example apparatus 10 without use of the curve-flattening techniques disclosed herein—i.e., any one or more of progressive blocking or defocusing, along with complementary lens design. The sensitivity curve 122 illustrates the flattening effects provided by the combination of progressive blocking and defocusing, along with a complementary design of the lens 50.

Both curves 120 and 122 show the optical power delivered to the photodetector 54 of the apparatus 10, with respect to a given object moved through a range of distances, e.g., out to some maximum detection distance of the apparatus 10. The curve 122 exhibits a more uniform power delivery over the range—i.e., the curve 122 is flatter than the curve 120. Improvements are seen in the closest and next-closest ranges of distance, labeled A and B in the diagram, at the expense of lower power delivery across all three ranges A. B, and C.

Range A may be understood as including distances for which the apparatus 10 exhibits poor focusing performance, whereas Range B may be understood as a near-field range of distances, where focusing performance of the apparatus 10 begins improving, although the backscattered light 18 received by the apparatus 10 is not paraxial with the optical axis of the optical receiver arrangement 16. Range C may be understood as a far-field range of distances, out to some maximum distance, wherein the backscattered light 18 received by the apparatus 10 tends towards the paraxial approximation with increasing distance.

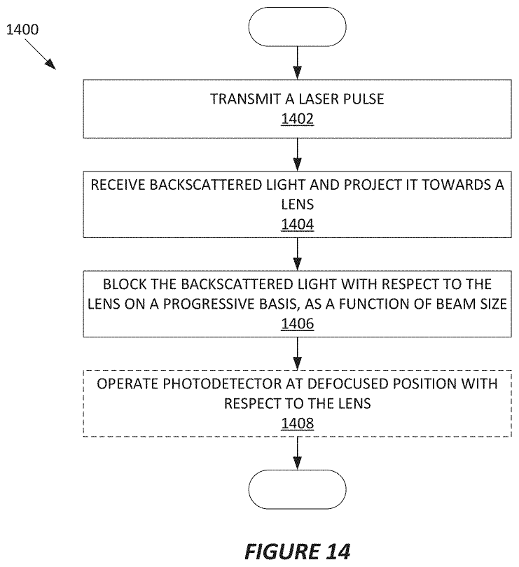

FIG. 14 illustrates a method 1400 performed by a laser scanner apparatus 10 according to one or more embodiments. The method 1400 includes transmitting (Block 1402) a laser pulse into a surrounding physical environment of the apparatus 10, receiving (Block 1404) backscattered light and projecting it towards a lens as a projected beam centered on the optical axis of the lens, wherein the lens operates as a focusing lens for a photodetector of the apparatus 10 that is used to sense backscattered light. Further, the method 1400 includes blocking (1406) the backscattered light with respect to the lens, for beam sizes of the projected beam that exceed a first beam size, wherein the blocking is progressive as a function of radial distance from the optical axis of the lens, for beam sizes between the first beam size and a larger, second beam size.

As one example, the first beam size corresponds to a first object distance that represents the beginning of a far-field distance range of the apparatus 10 for which the backscattered light returned to the apparatus 10 takes on a paraxial approximation. Correspondingly, the second beam size corresponds to a minimum specified object distance, with object distances between the minimum specified object distance and the beginning of the far-field distance range being a near-field detection range of the apparatus 10 for which the paraxial approximation does not hold.

The method 1400 in one or more embodiments further includes operating (Block 1408) the photodetector at a defocused position with respect to the lens. In this regard, the apparatus 10 may include an internal structure or subassembly that purposefully locates the photodetector at a fixed position along the optical axis of the lens, where that fixed position is offset from the focal plane of the lens. That is, the active surface of the photodetector does not lie in the focal plane of the lens. The offset position may be towards or away from the lens.

Among the various goals or benefits associated with the method 1400 and other embodiments detailed herein is a flattening of the sensitivity curve of a laser scanner apparatus, where the sensitivity curve refers to the optical power delivered to the photodetector of the apparatus as a function of the distance from the apparatus to the object being detected. As an added benefit, the associated circuit design and signal processing downstream from the photodetector is simplified because of the curve flattening. Metrics may be used to quantify the amount of flattening gained, and the metrics may be subdivided into far-field and near-field metrics. As an example, the near-field detection range of an example apparatus 10 spans the range of 0 to 1 meters of distance from the apparatus 10. An example far-field distance range then spans from the 1-meter mark out to a maximum distance of 6 meters. Of course, the apparatus 10 may be designed for detection over different distance ranges.

Thus, a working definition of the near-field sensitivity of an apparatus may be expressed as:

$$Near field sensitivity = \frac{\begin{matrix}Max power on photodetector when target \\ moves between 0 and 1000 mm\end{matrix}}{\begin{matrix}Power on the photodetector when \\ target is at 1000 mm\end{matrix}}$$

Here. “target” refers to the given object being detected.

A corresponding definition of the far-field sensitivity of the apparatus may be expressed as:

$$Far field sensitivity = \frac{\begin{matrix}Max power on photodetector when target \\ moves between 1000 and 6000 mm\end{matrix}}{\begin{matrix}Power on the photodetector when \\ target is at 6000 mm\end{matrix}}$$

The ideal values for both near field and far field sensitivity metrics is one (“1”), which means a constant horizontal sensitivity curve. Without the use of one or more of the compensating features disclosed herein, the sensitivity-curve metrics may exceed a value of 8. As detailed herein, an apparatus 10 includes one or more features that flatten the sensitivity curve across the far-field and near-field distance ranges, bringing the metric values into the range of 2 to 4, for example.

For example, with respect to the defocusing feature described herein, the defocusing technique positions the photodetector 54 at a location along the optical axis of the lens 50 that makes the optical power delivered to the photodetector 54 less strongly dependent on the extent to which the backscattered light 18 incoming to the optical receiver arrangement 16 deviates from the paraxial approximation. The amount of defocusing is calculated, for example, as a trade-off between sensitivity-curve flattening and the need to preserve detectable signal levels out to the maximum detection distance, for a defined range of object sizes and reflectivity.

Regarding the design of the lens 50 to complement defocusing of the photodetector 54 and/or progressive blocking by the aperture 46, the lens geometry is determined in accordance with a desired back focal length and focusing performance. As noted, the lens 50 may be configured as a bi-convex aspheric lens, and the size of the central region 80 of the aperture 46 may be set to a diameter just slightly smaller than the horizontal width of the scanning mirror 42.

The central region 80 of the aperture 46 is fully open in one or more embodiments, with the diameter of that opening mainly responsible for passing backscattered light from objects in the far field (where paraxial approximation is valid). Correspondingly, the annular region 82 of the aperture 46 may be regarded as a circular crown region with variable clarity or otherwise variable light-blocking, in dependence on radial distance from the optical axis of the lens 50. The annular region 82 is mainly responsible for controlling the light coming from near-field objects, where the paraxial approximation is not valid any longer. Central-region and annular-region dimensioning flows, for example, from considering the characteristic beam sizes of the projected beam 44 for the apparatus 10, over the far-field and near-field distance ranges.

For example, with reference back to FIG. 6, having the characteristic beam sizes and knowing the width of the scanning mirror 42 allows for the calculation of the subtended angles a1 and a2 corresponding to an object at distances d1 and d2. The subtended angle a is inversely proportional to “d” (when “d” increases, a decreases and vice versa). For example, considering two target positions d1 (in near field) and d2 (in far field), the subtended angle a1 is greater than the subtended angle a2.

Knowing the subtended angle a for each position d allows for the calculation of the fraction of beam power P enclosed in a and backscattered towards the mirror 42. For d1, the power backscattered towards the mirror 42 is P1, and, for d2, the power is P2. The ratio between P1 and P2 depends on the actual distances, where P1 can be either higher or lower than P2 depending on the specific positions d1 and d2. Further, P is only a fraction of the total power backscattered by the object at the distance d because it is only that portion of the backscattered light enclosed by the subtended angle a—i.e., that portion of the backscattered light that is returned to the mirror 42 of the apparatus 10 (labeled as backscattered light 18 in FIG. 1).

Knowing the angle a for each distance d, the area “b” of the backscattered beam projected by the mirror 42 onto the top surface of the aperture 46 may be calculated. As the subtended angle a varies with object distance d, these beam areas b also vary according to the distance d (i.e., the size of the projected beam 44 varies with object distance). For example, consider two target positions d1 (in near field) and d2 (in far field): the subtended angle a1 for d1 is greater than the subtended angle a2 for d2, and the beam area bi for d1 is greater than the beam area b2 for d2.

The foregoing geometric considerations provide for calculation of the average irradiance I (power per unit area) for each beam area b, which is assumed to be uniform within the beam area. For example, the projected-beam area b1 has irradiance I1 given by P1/b1, while the projected-beam area b2 has irradiance 12 given by P2/b2. Because the clear central region 80 of the aperture 46 is smaller than the projected-beam sizes b for near-field objects, the power P′ encircled within the central region 80 may be calculated for each area b, knowing its average irradiance I. That is P′=I*CA, where “CA” denotes the unobstructed clear area of the aperture 46, as provided by the central region 80. The power calculations must, however, also account for the transmitter module shadowing, as shown in FIG. 12. That adjusted power may be expressed as P“and it is based on an adjusted beam area b”, where b″=CA−area shadowed by the transmitter module). The power P″ reflects the power “conveyed” to the lens 50 via the central region 80 of the aperture, with the TX-module shadowing account for.

For an object at a distance d1 from the apparatus, the power delivered to the photodetector 54 may be expressed as P1″ and the power delivered to the photodetector 54 for an object at a distance d2 may be expressed as P2″. (Note, the P1″ and P2″ values may be as calculated above—i.e., they may be the optical power delivered to the lens 50 and then focused onto the photodetector 54, or they may deviate from the above calculations by amounts related to any defocusing applied for the photodetector 54 with respect to the lens 50.)

For a flat sensitivity curve, then for each object distance d, the power P″ delivered to the photodetector 45 must be the same, that is P1″=P2″ for distances d1 and d2. Because the optical power incoming to the apparatus 10 changes with distance, one mechanism for reducing the variation in the optical power delivered to the photodetector 54 over a range of optical distances is to operate on the beam shape of the resulting projected beam 44. That is, the aperture 46 can be understood in some sense as reshaping or controlling the projected beam 44, to provide beam areas b″ that vary less over object distance. The central region 80 is, for example, dimensioned in dependence on the optical power incoming to the apparatus 10 for far-field object detection. Further, the inner and outer diameters of the annular region 80, the amounts and progressiveness of the light blocking provided by it, may be determined based on dividing the annular region 82 into a series of small concentric circular crowns, such as seen in FIG. 8, with crown providing a certain amount of light blocking. There may be one concentric ring (crown) per each distance d considered in near field, each one with fixed width. For example, ringing the central region 80 with a sawtooth profile provides for a correspondingly greater reduction in the amount of light passing through the aperture 46 in the annular region 82, with increasing radius from the optical axis.

This progressive light reduction yields a corresponding reduction in transferred optical power, as between the mirror 42 and the lens 50, for that portion of the projected beam that falls onto the annular region 82. As such, the photodetector 54 does not experience as much variation in the optical power delivered to it, over the range of object distances corresponding to beam sizes affected by the annular region 82.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A laser scanner apparatus comprising:
an optical transmitter arrangement configured to transmit a laser pulse into a surrounding physical environment of the laser scanner apparatus; and
an optical receiver arrangement that is configured to receive backscattered light at a mirror and project the received backscattered light as a projected beam towards an aperture interposed between a lens and the mirror, the lens configured to focus backscattered light passed by the aperture towards a photodetector, the aperture configured to impart no blocking of the projected beam with respect to the lens, for beam sizes that do not exceed a fixed central region of the aperture, and impart a variable blocking of the projected beam with respect to the lens, for beam sizes that are larger than the central region of the aperture, the variable blocking provided by a fixed annular region of the aperture surrounding the central region, with the amount of blocking increasing within the annular region as a function of radial distance from the optical axis of the lens, on which the central region of the aperture is centered.

2. The laser scanner apparatus of claim 1, wherein, at least for a defined range of distances, the variable blocking reduces distance-related variations in the optical power delivered to the photodetector that would otherwise arise as a consequence of the beam size of the projected beam being dependent upon the distance between the laser scanner apparatus and an object in the surrounding environment that provides the backscattered light received by the laser scanner apparatus.

3. The laser scanner apparatus of claim 2, wherein, in cases where the beam size of the projected beam does not exceed the size of the central region of the aperture, the aperture imparts no reduction in the optical power delivered to the photodetector, and wherein, in cases where the beam size of the projected beam exceeds the size of the central region of the aperture, the aperture imparts a reduction in the optical power delivered to the photodetector, with the amount of the reduction depending on the beam size.

4. The laser scanner apparatus of claim 1, wherein the size of the central region is dimensioned for beam sizes of the projected beam that correspond to a first range of distances, and wherein an overall size of the central region plus the annular region is dimensioned for beam sizes of the projected beam that correspond to a second range of distances, wherein distances in the second range are closer to the laser scanner apparatus than distances in the first range, and wherein backscattered light returned to the laser scanner apparatus from objects at distances in the first range is substantially paraxial with the optical axis of the lens and backscattered light returned to the laser scanner apparatus from objects at distances in the second range is not substantially paraxial with the optical axis of the lens.

5. The laser scanner apparatus of claim 1, wherein a circumferential edge of the aperture surrounds the central region of the aperture, which is open, and wherein the circumferential edge has a sawtooth contour.

6. The laser scanner apparatus of claim 1, wherein the central region of the aperture is open and ringed by plurality of circumferentially-arrayed tapered projections having tips extending towards the center of the aperture and terminating at a first radial distance from the center of the aperture, the first radial distance defining the size of the central region and the tapered projections providing increased beam blocking with increasing radial distance from the center of the aperture.

7. The laser scanner apparatus of claim 1, wherein the optical receiver arrangement includes a photodetector that provides an output signal responsive to the projected beam, as directed towards the photodetector by the lens, and wherein an active surface of the photodetector is positioned along the optical axis of the lens at an offset from the focal plane of lens.

8. The laser scanner apparatus of claim 1, wherein the offset positions the active surface of the photodetector closer to the lens, so that less than all the projected beam, as redirected by the lens towards the photodetector, falls on the active surface of the photodetector, for beam sizes greater than a defined size.

9. The laser scanner apparatus of claim 8, wherein the defined size corresponds to a near-field range of distances from the laser scanner apparatus.

10. The laser scanner apparatus of claim 1, wherein a spacing between the lens and a photodetector used to detect the projected beam, as redirected by the lens, partially defocuses the photodetector with respect to the lens, to flatten a sensitivity curve of the laser scanner apparatus that is associated with characteristically higher beam powers of the backscattered light, for an object that is within a near-field distance range from the laser scanner apparatus, as compared to a far-field distance range.

11. The laser scanner apparatus of claim 10, wherein an amount of defocusing is configured to provide a certain amount of flattening of the sensitivity curve, while preserving a minimum sensitivity of the optical receiver arrangement.

12. The laser scanner apparatus of claim 1, wherein the lens is a bi-convex aspheric lens, and wherein the unobstructed central region of the aperture is a circular area having a diameter that is less than a width of a reflecting surface of the mirror available for projecting the backscattered light towards the aperture.

13. The laser scanner apparatus of claim 12, wherein a photodetector used to detect the projected beam, as redirected by the lens, occupies a position closer to the lens along the optical axis of the lens than the focal plane of the lens, such that the photodetector is defocused by a certain amount with respect to the lens.

14. A method performed by a laser scanner apparatus, the method comprising:
transmitting a laser pulse into a surrounding physical environment of the laser scanner apparatus;
receiving backscattered light and projecting it towards a lens as a projected beam centered on the optical axis of the lens, wherein the lens operates as a focusing lens for a photodetector of the laser scanner apparatus that is used to sense backscattered light; and
blocking the backscattered light with respect to the lens, for beam sizes of the projected beam that exceed a first beam size, wherein the blocking is progressive as a function of radial distance from the optical axis of the lens, for beam sizes between the first beam size and a larger, second beam size.

15. The method of claim 14, wherein the rust beam size corresponds to a first object distance that represents the beginning of a far-field distance range of the laser scanner apparatus for which the backscattered light returned to the laser scanner apparatus takes on a paraxial approximation, and wherein the second beam size corresponds to a minimum specified object distance, with object distances between the minimum specified object distance and the beginning of the far-field distance range being a near-field detection range of the laser scanner apparatus for which the paraxial approximation does not hold.

16. The method of claim 14, further comprising operating the photodetector at a defocused position with respect to the lens.

17. The method of claim 16, wherein the defocused position is offset from the focal plane of the lens, towards the lens.

18. The method of claim 16, wherein the defocused position is offset from the focal plane of the lens, away from the lens.
